(19) United States
(12) Patent Application Publication
(10) Pub. No.: US 2008/0265063 A1
(43) Pub. Date: Oct. 30, 2008

(54) SPRAY NOZZLE

(75) Inventors: Raymond C. Schmidt, Dixon, IL (US); Charles B. Spear, Byron, IL (US); William Joseph REX, Dixon, IL (US); Michael J. NAYLON, Polo, IL (US)

Correspondence Address: MCNEES WALLACE & NURICK LLC, 100 PINE ST., P.O. BOX 1166, HARRISBURG, PA, 17108-1166, US

(73) Assignee: JOHNSON CONTROLS TECHNOLOGY COMPANY, Holland, MI (US)

(21) Appl. No.: 11/741,880

(22) Filed: Apr. 30, 2007

(51) Int. Cl. B05B 1/26

(52) U.S. Cl. 239/518; 29/428

(57) ABSTRACT

A spray nozzle for directing a fluid into a desired uniform spray pattern is disclosed that includes a nozzle body, a spray plate and a deflector plate. The spray nozzle may be formed of replaceable components to allow for modifications to the individual components to change the spray pattern.

### BACKGROUND

The application generally relates to a liquid spray device for use in gas and liquid contact systems. The application relates more specifically to a spray nozzle for use in evaporative cooling components, such as cooling towers, fluid coolers and condensers.

In gas and liquid contact systems, such as cooling towers used for reducing the temperature of a cooling liquid from a manufacturing plant or other facility, liquid is distributed over the top of fill elements and cooled by a cross or countercurrent flow of a gas, such as air. The liquid is typically water and the distribution is by spray nozzles that distribute the water evenly over the heat exchanger elements.

Most often, the water to be cooled is sprayed from above onto the heat exchanger elements by a nozzle. In order to provide maximum contact time between the water and the air to maximize cooling efficiency, it is essential that the water be disbursed evenly over the heat exchanger elements to uniformly wet a specified area and that the water be allowed to flow smoothly through these elements. Thus, nozzles are designed to provide a determinable spray area at a specified flow rate to allow for optimum liquid distribution.

There have been many efforts in the past to devise nozzles for use in evaporative applications to meet these objectives. These prior attempts have failed to provide a nozzle that provides for an even spray pattern because of obstructions in the spray path from structural members of the nozzle or because of inherent limitations in the nozzle design.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

A first embodiment relates to a spray nozzle including a nozzle body, a spray plate connected to the nozzle body, and a deflector plate having a concave section and a connecting member connected to the nozzle body, wherein the concave section substantially reverses the direction of fluid flowing through the nozzle body toward the spray plate, and wherein the spray plate substantially reverses the direction of fluid from the deflector plate into a uniform spray pattern.

The first embodiment further includes the nozzle body having a tube section, a plate section and a fluid flow hole having a center axis, wherein the plate section comprises an upper surface, a lower surface, and through holes, and wherein the spray plate comprises an top surface and a bottom surface, where the top surface of the spray plate includes teeth that assist in directing fluid flow into the spray pattern. The teeth including teeth configured to face the center axis of the fluid flow hole of the nozzle body.

The first embodiment also includes the bottom surface of the spray plate having a recess for receiving the upper surface of the plate section, and wherein the spray plate has an octagonal perimeter. The first embodiment also includes the plate section of the nozzle body and the spray body having through holes for receiving the connecting member of the deflector plate.

The first embodiment additionally includes the connecting member being thermally welded to the plate section of the nozzle body, and the nozzle body, the spray plate, and the deflector plate are formed of a rigid plastic. The first embodiment also additionally includes the rigid plastic being selected from a group comprising a polyolefin copolymer, a polypropylene and a polyvinyl chloride.

A second embodiment relates to a method of forming a spray nozzle including providing a nozzle body having a tube section and a plate section, connecting a spray plate to the nozzle body, and connecting a deflector plate to the spray plate. The second embodiment further includes the deflector plate having a concave section and a connecting member, and the spray plate having a top surface and a bottom surface, the top surface includes teeth that assist in directing fluid flow into a spray pattern.

The second embodiment further includes the spray plate having through holes, and the bottom surface of the spray plate has a recess for receiving the upper surface of the plate section. The plate section of the nozzle body includes an upper surface, a lower surface, and through holes. The second embodiment also includes the connecting of the deflector plate including passing the connecting member first through the through holes of the spray plate and then through the through holes of the plate section, and then attaching the connecting member to the bottom surface of the plate section.

The second embodiment additionally includes the connecting member being attached by thermal welding, and the top surface of the spray plate includes fluid directing teeth. The second embodiment also additionally includes wherein the nozzle body, spray plate, and deflector plate are formed of a rigid plastic, and wherein the rigid plastic is selected from a group comprising a polyolefin copolymer, a polypropylene and a polyvinyl chloride.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a side view of an exemplary embodiment of the invention.

FIG. 2 is a side view of a nozzle body of an exemplary embodiment of the invention.

FIG. 3 is a top view of a nozzle body of an exemplary embodiment of the invention.

FIG. 4 is a side view of a spray plate of an exemplary embodiment of the invention.

FIG. 5 is a top view of a spray plate of an exemplary embodiment of the invention.

FIG. 6 is a bottom view of a spray plate of an exemplary embodiment of the invention.

FIG. 7 is a side view of a deflector plate of an exemplary embodiment of the invention.

FIG. 8 is a bottom view of a deflector plate in accordance with an exemplary embodiment of the invention.

FIG. 9 is a top view of an exemplary embodiment of the invention.

FIG. 10 is a side view of an exemplary embodiment of the invention connected to a fluid supply.

### DETAILED DESCRIPTION OF THE EXEMPLARY EMBODIMENTS

Before turning to the figures, which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

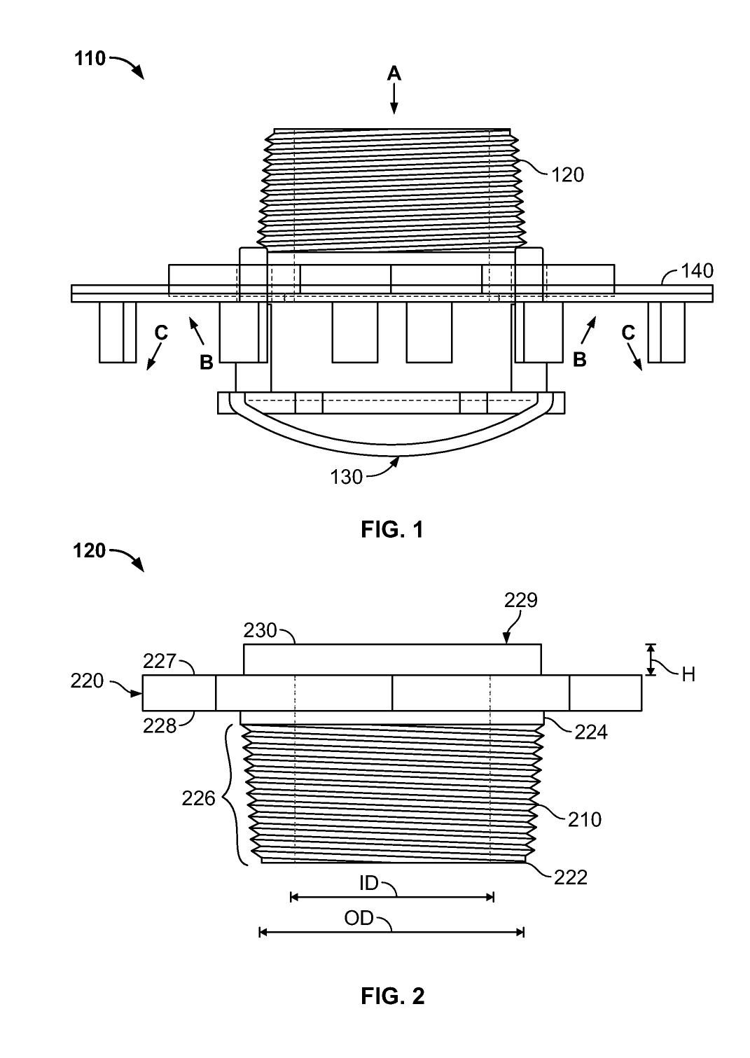

Referring to FIG. 1, there is shown a side view of an exemplary embodiment of a spray nozzle 110 according to the invention. Spray nozzle 110 includes a nozzle body 120, a deflector plate 130, and a spray plate 140. A fluid enters the nozzle body 120 from a direction indicated by arrow A, and is redirected by the deflector plate 130 towards the spray plate 140 as indicated by arrow B. The fluid is then redirected by the spray plate 140 into a desired spray pattern in a direction indicated by arrow C.

The spray nozzle 110 may be formed of a rigid plastic material. The plastic material may be a thermoplastic material. The thermoplastic material may be a polyolefin copolymer, a polypropylene, a polyvinyl chloride, or other suitable material.

In this exemplary embodiment, the spray nozzle 110 is formed by assembling a nozzle body 120, a deflector plate 130, and a spray plate 140 that have been molded as separate components. This exemplary embodiment allows the spray nozzle 110 to be modified without modifying all of the components. For example, the spray plate 140 may be modified to provide a different spray pattern without modifying the nozzle body 120 or deflector plate 130. Alternatively, the spray nozzle 110 may be formed by molding the nozzle body 120, the deflector plate 130, and the spray plate 140 as a single body.

As seen in FIG. 2, a side view of the exemplary embodiment of the nozzle body 120 is shown that includes a tube section 210 and a plate section 220. The tube section 210 is used to attach the spray nozzle 110 to a fluid supply (not shown). The fluid supply may be a pipe or housing from a tank, basin, or other fluid source. The plate section 220 is used to attach the spray plate 140 to the nozzle body 120.

In this exemplary embodiment, the nozzle body 120 is a single molded body. In an alternative embodiment, the tube section 210 and plate section 220 may be individually molded and assembled. The tube section 210 and the plate section 220 may be assembled by thermal welding, gluing, or other attachment methods known in the art.

The tube section 210 includes an inlet end 222 and an outlet end 224. The tube section 210 further includes an inside diameter ID and an outside diameter OD. The tube section 210 is provided with threads 226 to assist in attaching the inlet end 222 to a liquid supply (not shown). The threads 226 may cover the tube section, or may only cover a portion of the tube section 210 as shown. The liquid supply may be a pipe adapted to receive the threads 226. The threads 226 are shown on the OD of the tube section 210, but may alternatively be on the ID of the tube section 210. In an alternative configuration, the tube section 210 may not be threaded and may be attached to a liquid supply by other methods including gluing, thermal welding or other attachment method.

The plate section 220 is located proximate to the outlet end 224 of the tube section 210. The plate section 220 includes a top surface 227 and a bottom surface 228. The top surface 227 includes a raised ring 229. The raised ring includes a top surface 230. The raised ring 229 has a height H above the top surface 227. In this exemplary embodiment, the tube section 210 and the plate section 220 are molded as a single nozzle body 120 component.

In an alternative embodiment, the tube section 210 and the plate section 220 may be formed as separate components and attached together. The tube section 210 and the plate section 220 may be attached by thermal welding, gluing, or other attachment methods. In this alternative embodiment, the raised ring 229 may be formed by a portion of the tube section 210 extending through the plate section 220.

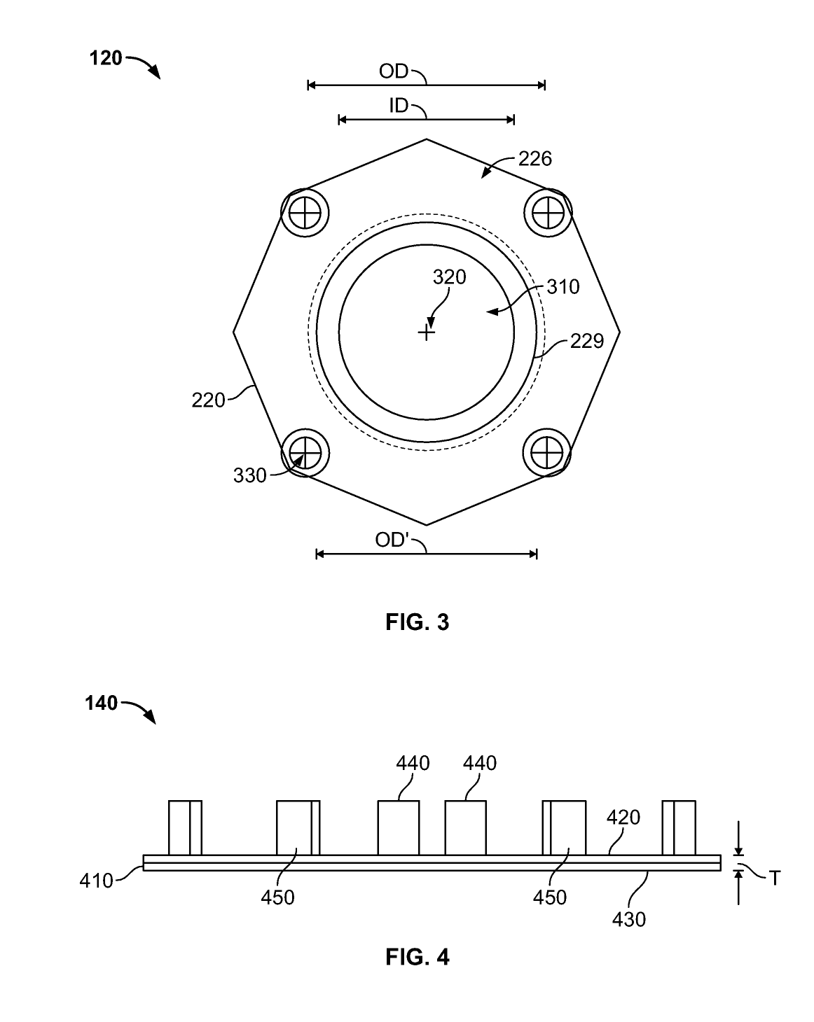

A top view of the exemplary nozzle body 120 is shown in FIG. 3. As shown in FIG. 3, the nozzle body 120 includes a flow hole 310 having a flow hole center axis 320. The plate section 220 is shown having an octagonal perimeter. However, the perimeter may be square, hexagonal, or other symmetric shape. The perimeter is preferably a symmetric cornered shape such as hexagonal to assist in aligning nozzle body 120 with the spray plate 140 during assembly.

As can be further seen in FIG. 3, the raised ring 229 includes an inside diameter ID′ and an outside diameter OD′. The inside diameter ID′ of the raised ring 229 is the same distance as the inside diameter ID of the tube section 210. The outside diameter OD′ of the raised ring 229 is shown as less than the OD of the tube section 210, but may be the same or larger. The plate section 220 further includes through holes 340 that extend through the top surface 226 and bottom surface 228 (shown in FIG. 2).

FIGS. 4, 5 and 6 show a side view, a top view, and a bottom view of the exemplary spray plate 140, respectively. As shown in FIG. 4, the spray plate 140 includes a spray plate body 410 including a top surface 420 and a bottom surface 430. The spray plate 140 has a thickness T. Disposed on the top surface 410 are a plurality of center teeth 440 and corner teeth 450. The center teeth 440 and corner teeth 450 assist in directing the flow of water from the spray plate top surface 420.

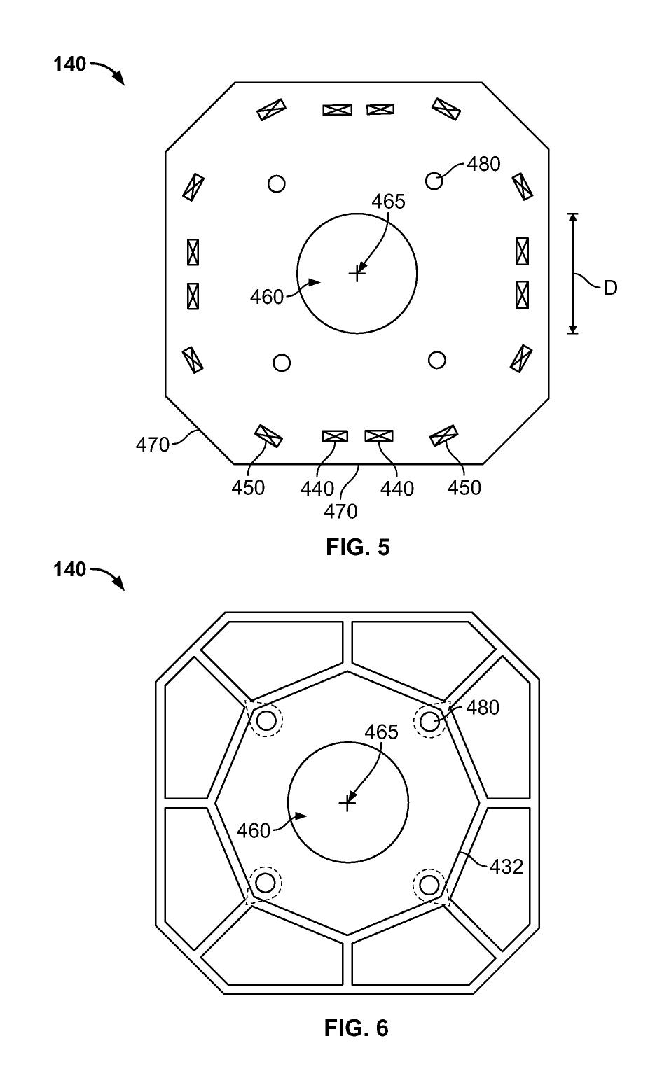

As shown in FIG. 5, the spray plate 140 includes a fluid flow hole 460 having a diameter D and a center axis 465. The diameter D is slightly larger than the outside diameter OD′ of the raised ring 229 to allow the raised ring to fit tightly inside the flow hole 460 when assembled. Also, the height H (shown in FIG. 2) of the raised ring 229 is selected so as to allow the top surface 230 of the raised ring 229 to be aligned with the top surface 420 of the spray plate 140. In other words, the height H of the raised ring 229 is substantially the same as the thickness T of the spray plate 140. As can be seen in FIG. 5, the corner teeth are configured to face the center axis 465.

The spray plate 140 further includes a plurality of sides 470 of two or more different lengths. The lengths and arrangement of the sides 470 are determined by the desired spray pattern to be formed by the spray plate 140. The lengths and arrangement of the sides 470 may also be determined by the surface upon which the spray nozzle 110 is attached, so as to lock-in the spray plate 140 into such a surface. The sides 470 may form an octagonal pattern using sides 470 of two different lengths as shown in FIG. 5, but the sides 470 may also form other cornered perimeters.

The center teeth 440 are aligned with the sides 470 as shown, and the corner teeth 450 are aligned to face the center axis 465 of the flow hole 460 as shown. The number and angle of the center teeth 440 and the corner teeth 450 may be varied based on the desired spray pattern. Additionally, the size of the center teeth 440 and the corner teeth 450 may be varied to generate a desired spray pattern.

As can be further seen in FIGS. 4 and 5, the spray plate 140 also includes though holes 480 extending through the top surface 420 and the bottom surface 430. The through holes 480 are arranged to be aligned with through holes 330 of the plate section 220 of the nozzle body 120 when assembled.

As is shown in FIG. 6, the bottom surface 430 includes a recess 432 for receiving the plate section 220 of the nozzle body 120. The recess 432 is the same perimeter shape as the plate member 220, which in this exemplary embodiment is octangonal. The recess assists in aligning the center axis 465 of the fluid flow hole 460 of the spray plate 140 with the center axis 320 of the fluid flow hole 310 of the nozzle body 120.

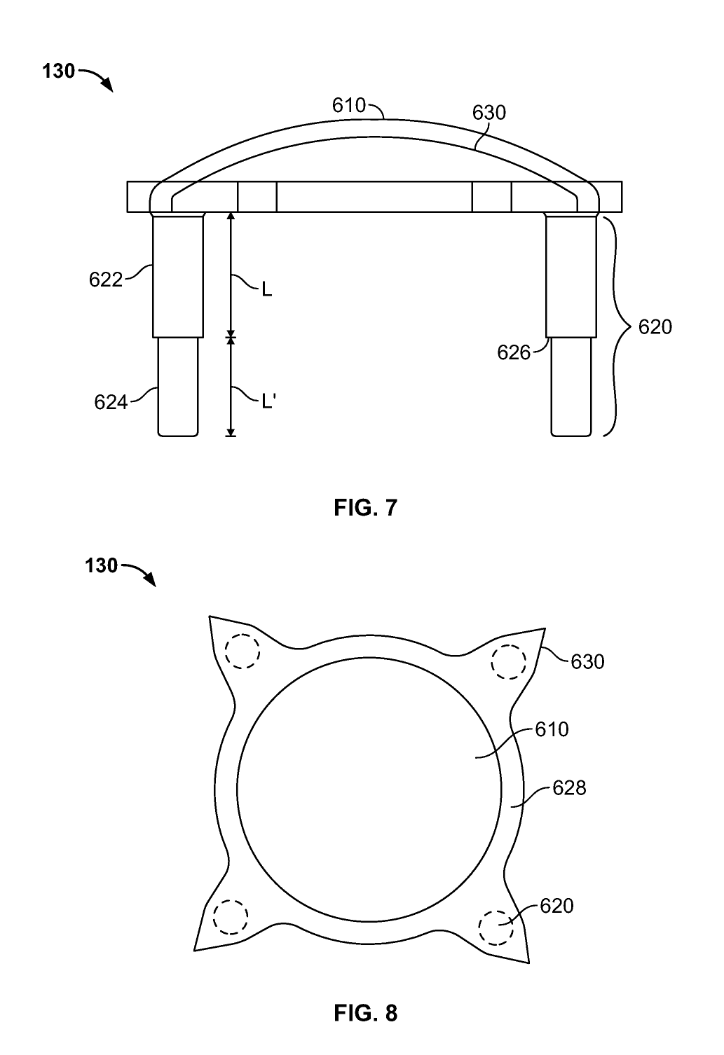

A side and a bottom view of the exemplary deflector plate 130 are shown in FIGS. 7 and 8, respectively. As shown in FIG. 7, the deflector plate 130 includes a concave member 610 and a connecting member 620. The concave member 610 and the connecting member 620 may be molded as a single component. Alternatively, the concave member 610 and the connecting member 620 may be molded as separate components and assembled by thermal welding, gluing, or other attachment methods.

The concave member 610 includes a concave surface 630 that substantially reverses the direction of fluid flowing from the nozzle body 120. In doing so, the fluid flow is directed towards the spray plate top surface 420. The radius of the concave surface 630 may be adjusted to affect the pattern of fluid directed towards the spray plate surface 420.

As further shown in FIG. 7, the connecting member 620 includes a post section 622 having a length L and an insert section 624 having a length L′. The post section 622 and the insert section 624 meet at transition point 626. The insert section 624 is sized to pass through the through holes 480 of the spray plate 140 and to pass through the through holes 330 of the plate section 220 of the nozzle body 120 when the spray nozzle 110 is assembled. The insert section 624 may then be attached to the bottom surface of the plate section 220 by thermal welding, gluing or other attachment method to secure the deflector plate 130, the spray plate 140, and the nozzle body 120 together. The post section 622 is sized to not pass through the through holes 480 of the spray plate 140 and not to pass through the through holes 330 of the plate section 220 of the nozzle body 120. When assembled, the post section 622 at the transition point 626 is positioned against the top surface 420 of the spray plate 140 and fixes the concave section 610 at a predetermined distance L from the top surface 420 of the spray plate 140.

As shown in FIG. 8, the concave surface 610 is surrounded by a raised edge 628 that surrounds the concave surface 610. The raised edge 628 further directs the fluid redirected by the concave surface 610 towards the spray plate top surface 420. The raised edge 628 includes extended supports 630 that are attached to the connecting member 620.

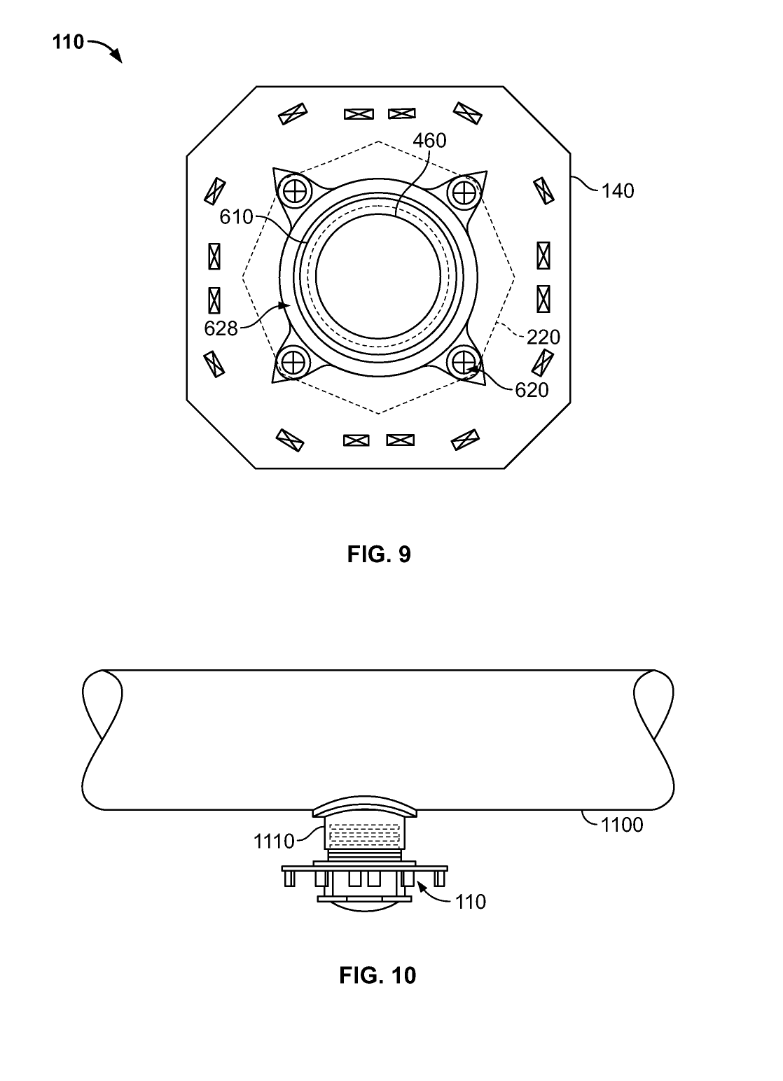

FIG. 9 shows a top view of the spray nozzle 110. As can be seen in FIG. 9, the concave member 610 is positioned centered over the spray plate 140 and the plate section 220. FIG. 9 further shows the arrangement of the connecting members 620 upon the spray plate 140, and the arrangement of the concave surface 610 and the raised edge 628 to the flow hole 460.

An exemplary arrangement of a spray nozzle 110 and a fluid supply pipe 1100 is shown in FIG. 10. Fluid supply pipe 1100 includes feed pipe 1110 that provides a fluid flow to the spray nozzle 110. In this exemplary arrangement, feed pipe 1110 has internal threads (not shown) that engage the threads 226 of the nozzle body 120. The spray nozzle 110 may be attached to the feed pipe 1110 by other attachment methods including gluing and thermal welding.

An exemplary method of assembling the spray nozzle 110 will now be described. The spray nozzle 110 is assembled by bringing the top surface 227 of the plate section 220 of the nozzle body 120 into contact with the recess 432 of the bottom surface 430 of the spray plate 140. The raised ring 229 of the nozzle body is inserted into the fluid flow hole 460 of the spray plate 140 and the through holes 330 of the plate section 220 are aligned with the through holes 480 of the spray plate 140. The cornered symmetric perimeter of the plate section 220 assists with alignment of the through holes 330 and through holes 480 since the plate section 220 will lock into the recess 432 and not be able to rotate therewithin.

Next, the insert section 624 of the connecting member 620 of the deflector plate 130 is inserted and passed through the through hole 480 of the spray plate 140 and through the through hole 330 of the plate section 220 of the spray nozzle 120. The length L′ of the insert section 624 is selected such that the insert section 624 terminates or extends slightly beyond the bottom surface 228 of the plate section 220. The insert section 624 is attached at the bottom surface 228 of the plate section 220 by thermal welding, gluing or other attachment method to permanently assemble the spray nozzle 110. The post section 622 may be attached to the top surface 420 of the spray plate 140 by thermal welding, gluing or other attachment methods to further permanently assemble the spray nozzle 110.

The spray nozzle 110 may be connected to a fluid supply (not shown) by threading the tube section 210 of the nozzle body 120 into a plank or board used in forming a tank or basin for holding fluid for distribution. Alternatively, the tube section 210 may be passed through a plank or board where it may receive a nut or other fastening means to secure the spray nozzle 110 to the plank or board. Alternatively, the tube section 210 may not be threaded and may be attached to a fluid supply by attachment methods including thermal welding and gluing. The shape of the spray plate 140 may be used to lock-in the spray nozzle 110 into the tank or basin.

The spray nozzle 110 may be connected to a fluid supply such as a pipe. The tube section 210 may be attached to a fluid supply pipe by threading, gluing, thermal welding or other attachment method.

The spray nozzle 110 disclosed provides a uniform spray pattern over a wide spray pattern area. The spray plate 140, center teeth 440 and corner teeth 450 may be further modified to alter the spray pattern geometry. Additionally, the geometry and size of the spray nozzle features may be adjusted based on required fluid flow and spray area coverage.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

It is important to note that the construction and arrangement of the spray nozzle as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

What is claimed is:

1. A spray nozzle comprising:
a nozzle body;
a spray plate connected to the nozzle body;
a deflector plate connected to the nozzle body and spray plate comprising a concave section and a connecting member;
the concave section substantially reverses the direction of fluid flowing through the nozzle body toward the spray plate;
the spray plate substantially reverses the direction of fluid from the deflector plate into a spray pattern; and
wherein at least one of the nozzle body, the spray plate, and the deflector plate is replaceable.

2. The spray nozzle of claim 1, wherein the nozzle body comprises a tube section, a plate section, and a fluid flow hole having a center axis, wherein the plate section comprises a top surface, a bottom surface, and through holes.

3. The spray nozzle of claim 2, wherein the spray plate comprises a top surface, a bottom surface opposite the top surface, and a plurality of teeth disposed on the top surface that assist in directing fluid flow into the spray pattern.

4. The spray nozzle of claim 3, wherein the plurality of teeth include teeth configured to face the center axis of the fluid flow hole of the nozzle body.

5. The spray nozzle of claim 4, wherein the bottom surface of the spray plate has a recess for receiving the top surface of the plate section.

6. The spray nozzle of claim 5, wherein the spray plate has an octagonal perimeter.

7. The spray nozzle of claim 6, wherein the plate section of the nozzle body and the spray plate have through holes for receiving the connecting member of the deflector plate.

8. The spray nozzle of claim 8, wherein the connecting member is thermally welded to the plate section of the nozzle body to fix the concave section of the deflector plate at a predetermined distance from the splash plate.

9. The spray nozzle of claim 1, wherein the nozzle body, the spray plate, and the deflector plate are formed of a rigid plastic.

10. The spray nozzle of claim 9, wherein the rigid plastic is selected from a group comprising at least one of a polyolefin copolymer, a polypropylene and a polyvinyl chloride.

11. A method of method of forming a spray nozzle, comprising:
providing a nozzle body comprising a tube section, a plate section and a fluid flow hole having a center axis;
connecting a spray plate to the nozzle body; and
connecting a deflector plate to the spray plate;
wherein at least one of the nozzle body, the spray plate, and the deflector plate is replaceable.

12. The method of claim 11, wherein the deflector plate comprises a concave section and a connecting member

13. The method of claim 12, wherein the spray plate comprises a top surface and a bottom surface, the top surface including teeth that assist in directing fluid flow into a spray pattern.

14. The method of claim 13, wherein the teeth include teeth configured to face the center axis of the fluid flow hole of the nozzle body.

15. The method of claim 14, wherein the spray plate further comprises through holes, and wherein the bottom surface of the spray plate has a recess for receiving a top surface of the plate section.

16. The method of claim 15, wherein the plate section of the nozzle body comprises a top surface, a bottom surface, and through holes.

17. The method of claim 16, wherein the connecting of the deflector plate comprises passing the connecting member first through the through holes of the spray plate and then through the through holes of the plate section, and then attaching the connecting member to the bottom surface of the plate section.

18. The method of claim 17, wherein the connecting member is attached by thermal welding.

19. The method of claim 11, wherein the nozzle body, spray plate, and deflector plate are formed of a rigid plastic.

20. The method of claim 19, wherein the rigid plastic is selected from a group comprising at least one of a polyolefin copolymer, a polypropylene and a polyvinyl chloride.
